(19) United States
(12) Patent Application Publication
(10) Pub. No.: US 2010/0018358 A1
(43) Pub. Date: Jan. 28, 2010

(54) TOOL FOR SCREWS OR BOLTS

(76) Inventor: Robert W. Power, Amery, WI (US)

Correspondence Address: SCHWEGMAN, LUNDBERG & WOESSNER, P.A., P.O. BOX 2938, MINNEAPOLIS, MN, 55402, US

(21) Appl. No.: 12/441,228

(22) PCT Filed: Sep. 13, 2007
(86) PCT No.: PCT/US07/19859

§ 371 Date: Sep. 29, 2009

Related U.S. Application Data
(60) Provisional application No. 60/825,511, filed on Sep. 13, 2006.

(51) Int. Cl. B25B 13/32; B25B 13/28

(52) U.S. Cl. 81/90.2; 81/90.3; 173/1; 81/90.9

(57) ABSTRACT

An apparatus includes a handle and a socket coupled to the handle. The socket includes an open end to receive a head of a screw and has a selectively adjustable diameter. The apparatus further includes an actuator configured to tighten the socket.

### CLAIM OF PRIORITY

Benefit of priority is hereby claimed to U.S. Provisional Patent Application Ser. No. 60/825,511, filed on Sep. 13, 2006, which is herein incorporated by reference.

### BACKGROUND

Working with hose clamps can be difficult because they are often located in hard to reach areas such as auto and marine engines, or tight areas in many plumbing applications. The hose clamp screws typically are slotted hex design, enabling the user to use a standard screwdriver or nut driver.

Unfortunately, the user cannot always get two hands into the work area to steady the piece, and the clamps often rotate while trying to install or remove them, making it difficult to maintain contact between the tool and the clamp screw.

### SUMMARY

An apparatus includes a handle and a socket coupled to the handle. The socket includes an open end to receive a head of a screw and has a selectively adjustable diameter. The apparatus further includes an actuator configured to tighten the socket.

### BRIEF DESCRIPTION OF DRAWINGS

FIG. 1 shows perspective view of a tool for screws or bolts, in accordance with one embodiment.

FIG. 2 shows an end view of the tool of FIG. 1.

FIG. 3 shows the tool of FIG. 1.

FIG. 4 shows the tool of FIG. 1.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined or that other embodiments may be utilized and that structural changes may be made without departing from the spirit and scope of the present invention. The following detailed description is, therefore, not to be taken in a limiting sense, and the scope of the present invention is defined by the appended claims and their equivalents.

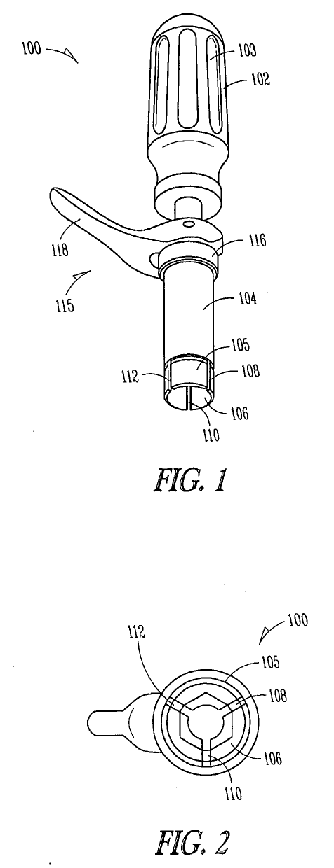

FIGS. 1-4 show an example embodiment of a tool 100, in accordance with one embodiment.

FIG. 1 shows perspective view of tool 100 and FIG. 2 shows an end view of the tool of FIG. 1. Tool 100 is a device which makes it easier to tighten screws or bolts. For example, tool 100 allows a user to more easily attach and remove worm screw hose clamps, as will be discussed below, and other types of screws. Tool 100 allows the user to grip the head of the screw so that a socket 105 of the tool is securely attached to the screw.

In one embodiment, tool 100 includes a handle 102 including a grip portion 103 and a shaft 104 extending from the grip portion 103. A socket 105 is attached to one end of the shaft 104. Socket 105 includes an open end 106 which is designed to fit over a hex shaped head of a screw in the same manner as a traditional nut driver. In one example, socket 105 includes one, two, three or more side wall sections separated by one, two, or three, or more longitudinal slots 108, 110, and 112 beginning at the end of the socket 105 and continuing toward the shaft. This configuration allows the diameter of the socket to be selectively adjustable so as to allow the socket 105 to be squeezed onto a head of a screw and tightly grip the screw.

Tool 100 further includes an actuator 115 configured to tighten the socket. The actuator 115 generally includes a sliding collar 116 which is mounted around the shaft 104, and a lever 118 movably affixed upon the shaft. Collar 116 includes a first end having a surface to engage a cam section 119 of lever 118. Compressing the lever 118 moves cam section 119 to push the collar 116 in a direction toward the socket 105. The socket 105 is located within an open end of the collar 116 such that when the collar 116 slides towards the socket 105, the collar 116 closes the slots 108, 110, and 112, thus reducing the diameter of the open end 106 of socket 105 and clamping the socket 105 onto the head of a screw. Lifting up or releasing the lever 118 releases the socket 105 and the tool 100 from the head of the screw.

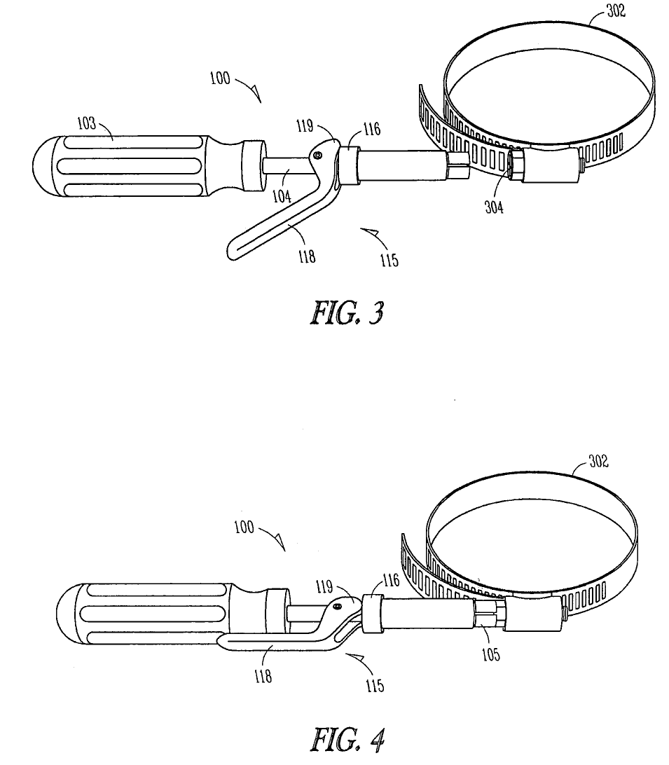

FIGS. 3 and 4 show an example use of tool 100 with FIG. 3 showing a side view of tool 100 and a hose clamp 302 and FIG. 4 showing tool 100 engaged with a screw 304 of the hose clamp 302.

To use the device, socket 105 is placed over the head of screw 304. As lever 118 is pressed, the lever 118 causes collar to slide up shaft 104. The collar 116 squeezes the socket 105 to decrease the diameter of the socket. Thus, tool 100 allows the user to grip the head of the screw 304 so that the socket 105 of the tool is securely attached to the screw 304 while the clamp 302 is being adjusted, installed, or removed.

In certain embodiments, the socket 105 can be a fixed size with an integral handle 102 and shaft 104, or the tool 100 may incorporate interchangeable sockets 105 of different size that work with interchangeable handles, shafts, and locking mechanisms. The handles and shafts may vary in length, and contain other features such as ratcheting and swiveling.

In some embodiments, the shaft 104 of the tool can be either rigid or of flexible design. In the case of the latter, the flexible shaft connected to the hex shaped socket 105 can be enclosed by another flexible cylindrically shaped shaft which possesses enough rigidity along the direction of its height so as to close the slots of the hex shaped socket when activated by the lever.

In addition to the above application, the tool also has numerous applications wherever traditional nut drivers or sockets are used, including many plumbing fixtures.

The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

1. An apparatus comprising:
a handle;
a socket coupled to the handle, the socket including an open end configured to receive a head of a screw and shaped to abut the side surfaces of the head of the screw, the socket including three or more side walls, the socket having a selectively adjustable diameter, wherein each of the side walls move towards the other side walls so as to abut the side surfaces of the screw; and
an actuator configured to reduce the diameter of the socket such that the side walls of the socket simultaneously apply force against the side walls of the head of the screw to grip the head of the screw.

2. The apparatus of claim 1, wherein the handle includes a grip portion and a shaft extending from the grip portion.

3. The apparatus of claim 1, wherein the actuator includes a lever movably attached to the handle.

4. The apparatus of claim 3, wherein the actuator further includes a collar positioned around the shaft and configured to translate up and down the shaft.

5. The apparatus of claim 4, wherein the collar includes an open end to receive the socket therein.

6. The apparatus of claim 5, wherein the collar is configured to squeeze the socket when the collar is translated towards the socket.

7. The apparatus of claim 1, wherein the socket includes at least three sections separated by slots.

8. An apparatus comprising:
a handle including a grip portion and a shaft, the shaft having a socket on one end, the socket including an open end designed to fit over a head of a screw and shaped to abut the side surfaces of the head of the screw, the socket including three or more slots beginning at the open end of the socket and three or more side walls defined by the slots, the side walls configured such that the diameter of the socket can be selectively adjusted such that each of the side walls move towards the other side walls so as to abut the side surfaces of the screw;
a sliding collar positioned on the shaft; and
a lever to push the collar up the shaft so as to reduce the diameter of the open end of the socket such that the side walls of the socket simultaneously apply force against the side walls of the head of the screw to grip the head of the screw.

9. The apparatus of claim 8, wherein the open end of the socket is configured to engage a hex head screw.

10. The apparatus of claim 8, wherein the collar is positioned around the shaft and configured to translate up and down the shaft.

11. The apparatus of claim 10, wherein the collar includes an open end to receive the socket therein.

12. The apparatus of claim 11, wherein the collar is configured to squeeze the socket when the collar is translated towards the socket.

13. The apparatus of claim 8, wherein the socket includes at least three sections separated by slots.

14. A method comprising:
placing a socket around a head of a screw, the socket including three or more side wall shaped to abut the side surfaces of the head of the screw;
engaging an actuator causing the socket side walls to move towards the other side walls so as to abut the side surfaces of the screw such that the side walls of the socket simultaneously apply force against the side walls of the head of the screw to tighten around the screw head so as to grip the screw head; and
disengaging the actuator when done screwing so as to loosen the socket from around the screw head.

15. The method of claim 14, wherein engaging an actuator includes pressing a lever so as to cause a collar to squeeze the socket.

16. An apparatus comprising:
a handle including a contoured grip portion and a shaft extending from the grip portion and aligned with the grip portion;
a socket coupled to the handle, the socket including an open end configured to receive a head of a screw and shaped to abut the side surfaces of the head of the screw, the socket including three or more side walls separated by slots, the socket having a selectively adjustable diameter, wherein each of the side walls move towards the other side walls so as to abut the side surfaces of the screw;
a lever movably attached to the handle; and
a collar positioned around the shaft and operatively coupled to the lever and configured to translate up and down the shaft to contact an outer surface of the socket so as to reduce the diameter of the socket such that the side walls of the socket simultaneously apply force against the side walls of the head of the screw to grip the head of the screw.

17. The apparatus of claim 16, wherein the collar is configured to squeeze the socket when the collar is translated towards the socket.

18. The apparatus of claim 16, wherein the lever is configured to be squeezed into the handle on an axis perpendicular to the axis of the shaft.
